(19) United States
(12) Patent Application Publication
(10) Pub. No.: US 2010/0114673 A1
(43) Pub. Date: May 6, 2010

(54) MEASURING THE RESPONSIVENESS OF INDIVIDUALS IN A SPECIFIED COLLABORATIVE ENVIRONMENT

(75) Inventors: Benjamin Hicks Briggs, Austin, TX (US); Pamela Ann Nesbitt, Ridgefield, CT (US); Amy Delphine Travis, Arlington, MA (US); Lorin Evan Ullmann, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/266,224

(22) Filed: Nov. 6, 2008

(51) Int. Cl. G06Q 10/00

(52) U.S. Cl. 705/11

(57) ABSTRACT

In a collaborative environment wherein persons use a specified system to communicate with one another, and a first person receives a request for information from one or more other persons, embodiments of the invention are used to provide a comprehensive measurement of collaboration that indicates the effectiveness of the first person in collaborating with one or more other persons in the environment. In an embodiment directed to a method, the embodiment includes, for each response made by the first person to one of the received requests, determining the value of at least one metric that represents the value of the response. The method further includes deriving one or more additional measurement values, wherein each additional measurement value represents the value of the participation of the first person in each of one or more additional measurable collaborative activities. The method further comprises selectively combining each of the metric values with each of the additional measurement values, and also with a prespecified policy, in order to produce the comprehensive measurement of collaboration.

### BACKGROUND OF THE INVENTION

1. Field of the Invention

The invention disclosed and claimed herein generally pertains to a method for measuring the comparative value of responses made by a person to other persons in a collaborative environment, wherein the responses are made to requests for information or other types of assistance. More particularly, the invention pertains to a method of the above type wherein objective or quantitative data that is related to the value or quality of each response is acquired automatically. Even more particularly, the invention pertains to a method of the above type wherein objective measured data that pertains to the value of respective responses is combined or aligned with measurable data acquired from other activities, in order to provide a comprehensive measurement that represents collaboration-related performance of a person in the collaborative environment.

2. Description of the Related Art

In technical and other departments of business organizations it is typically necessary for individual employees to continually collaborate or interact with one another, in order to exchange essential information or to render other assistance to one another. As a common example of such collaboration, a first employee needing an item of information will know that a second employee is already in possession of the information, or is able to acquire it much more quickly than the first employee. Thus, the first employee will request the second employee to provide the information. The second employee will then respond to the request in some way, where the response could include taking no action whatsoever.

Collaboration practices and issues typically pertain to things, such as responsiveness to queries, response time for matters relating to customers, and the usefulness of each response. It is readily apparent that in the above collaboration example, the value to the first employee of the response made by the second employee will be determined in significant part by the usefulness of the response, e.g., whether the requested information is provided completely, or is accurate. In addition, the value of the response to the first employee will largely depend on its timeliness, that is, how much time passes before the response is received.

It has been found that employees who are very effective at carrying out collaborations as described above frequently prove to be quite valuable to their organizations, and greatly facilitate the flow of work that their respective organizations produce. At the same time, however, these types of employee contributions are frequently not recognized, and employees are not compensated for such contributions. Currently used rating systems for employee awards and remuneration tend to be limited to more obvious accomplishments and to currently measurable results. The value to a business of the less tangible strengths of an employee, such as rapid response time in providing information to other employees, and dedication to helping peers, are generally not considered to be measurable targets against which an employee can compete, can endeavor to improve, or may be compensated for.

### BRIEF SUMMARY OF THE INVENTION

In a collaborative environment wherein persons use a specified system to communicate with one another, and a first person receives a request for information from one or more other persons, embodiments of the invention are used to provide a comprehensive measurement of collaboration that indicates the effectiveness of the first person in collaborating with one or more other persons in the environment. In an embodiment directed to a method, the embodiment includes, for each response made by the first person to one of the received requests, determining the value of at least one metric that represents the value of the response. The method further includes deriving one or more additional measurement values, wherein each additional measurement value represents the value of the participation of the first person in each of one or more additional measurable collaborative activities. The method further comprises selectively combining each of the metric values with each of the additional measurement values, and also with a prespecified policy, in order to produce the comprehensive measurement of collaboration.

### BRIEF DESCRIPTION OF THE SEVERAL VIEWS OF THE DRAWINGS

FIG. 1 is a block diagram that shows a number of components configured to implement an embodiment of the invention;

FIG. 2 is a schematic diagram depicting the display screen of a User Interface that shows information associated with an embodiment of the invention;

FIG. 3 is a flowchart that shows selected steps for a method comprising an embodiment of the invention; and

FIG. 4 is a block diagram showing a computer or data processing system for use in implementing an embodiment of the invention.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

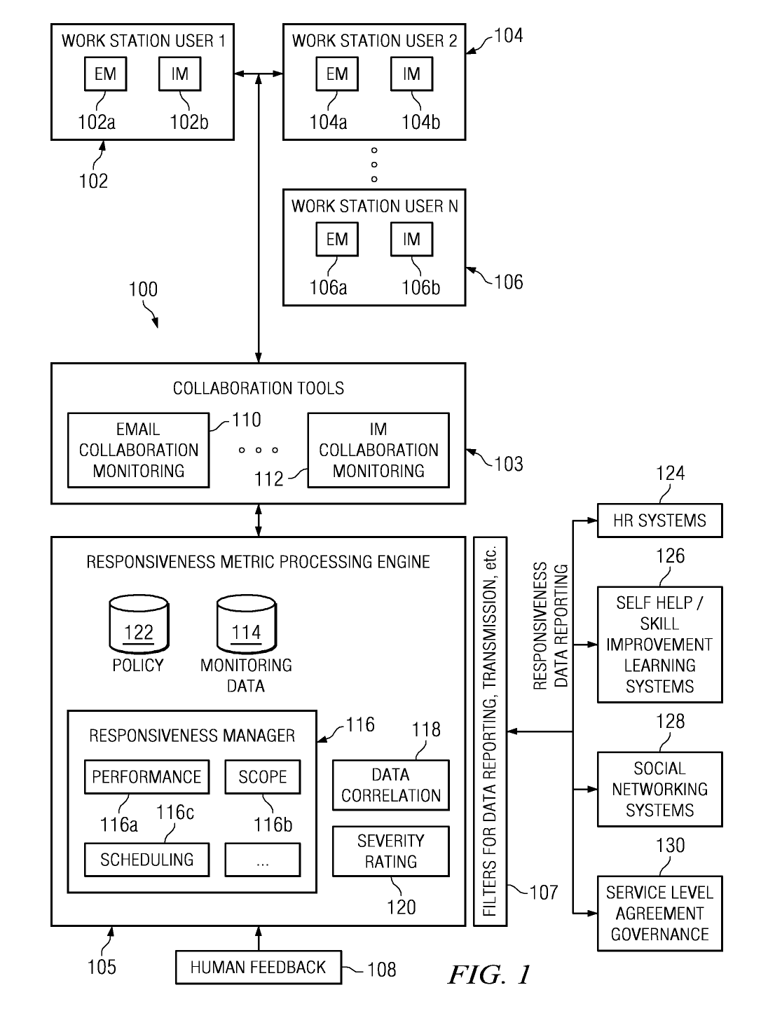

Referring to FIG. 1, there are shown work stations 102, 104 and 106 which represent the work stations respectively used by N persons, who are all members of a common organization, such as a work group or work team. The organization or work group could, for example, be a division or other defined unit of a business organization, but the invention is by no means limited thereto. In the course of conducting business and carrying out their respective duties, it is anticipated that each of the persons using work stations 1-N will collaborate or interact with one another in a number of ways. The organization or work group in which these activities take place is thus an example of a collaborative environment, as such term is used herein, although the invention is not limited thereto.

In accordance with a very common form of collaboration, a first user will receive requests for various information from other work station users. The first user will then respond in some way to each request. FIG. 1 shows each work station provided with the capability to communicate with other work stations by means of email components (102a, 104a, 106a) and also by means of instant messaging components (102b, 104b, 106b). Either of these communication modes can be used for collaborations of the above type, to send both requests for information and responses thereto. Of course, other conventional modes for sending messages between work stations, such as voicemail or the like, could alternatively be used.

At present, several approaches or techniques are available for assessing the responsiveness of employees or others in an organization. These include subjective rating procedures, such as surveys that ask employees or customers for feedback on an employee in regard to her/his responsiveness. Other approaches use objective ratings, such as tools that capture how quickly a customer issue was closed. However, these feedback techniques tend to operate in isolation from one another, and generally provide no way to validate subjective ratings with objective information. There is generally also no framework for integrating or effectively combining feedback information that has been obtained from different sources. In contrast to these practices, embodiments of the invention collect data from different sources, which all measure or represent the responsiveness and related contributions of an employee or other person in a collaborative environment. By combining or aligning data acquired from different sources, as described hereinafter in further detail, a comprehensive measurement of employee responsiveness can be produced. The comprehensive measurement may then be used by the organization for employee evaluation, or may be used by the employee for self improvement.

In order to achieve these objectives, FIG. 1 further shows a configuration of components 100, which cooperatively interact with one another and with work stations 102-106 to implement an embodiment of the invention. Configuration 100 includes a set of collaboration tools 103, which are linked to monitor emails and instant messages sent between respective work stations 102-106. Configuration 100 further includes a Responsiveness Metric Processing Engine 105, described hereinafter in further detail, and a data filter 107. A human feedback component 108 is provided to enable users at work stations 102-106 to enter feedback data into engine 105, as likewise described hereinafter.

FIG. 1 shows the set of collaboration tools 103 provided with a component 110 for email collaboration monitoring, that is, for monitoring each email sent from one of the work stations 102-106 to another work station thereof. Upon detecting the transmission of an email of this type, collaboration tools 103 automatically receive the email and record the time of transmission. Similar to the case of emails, collaboration tools 103 are provided with a component 112 for instant messaging (IM) collaboration monitoring, that is, for monitoring each instant message sent from one of the work stations 102-106 to another work station thereof. Upon detecting a transmission of an instant message of this type, collaboration tools 103 automatically receive the instant message and record the time of its transmission.

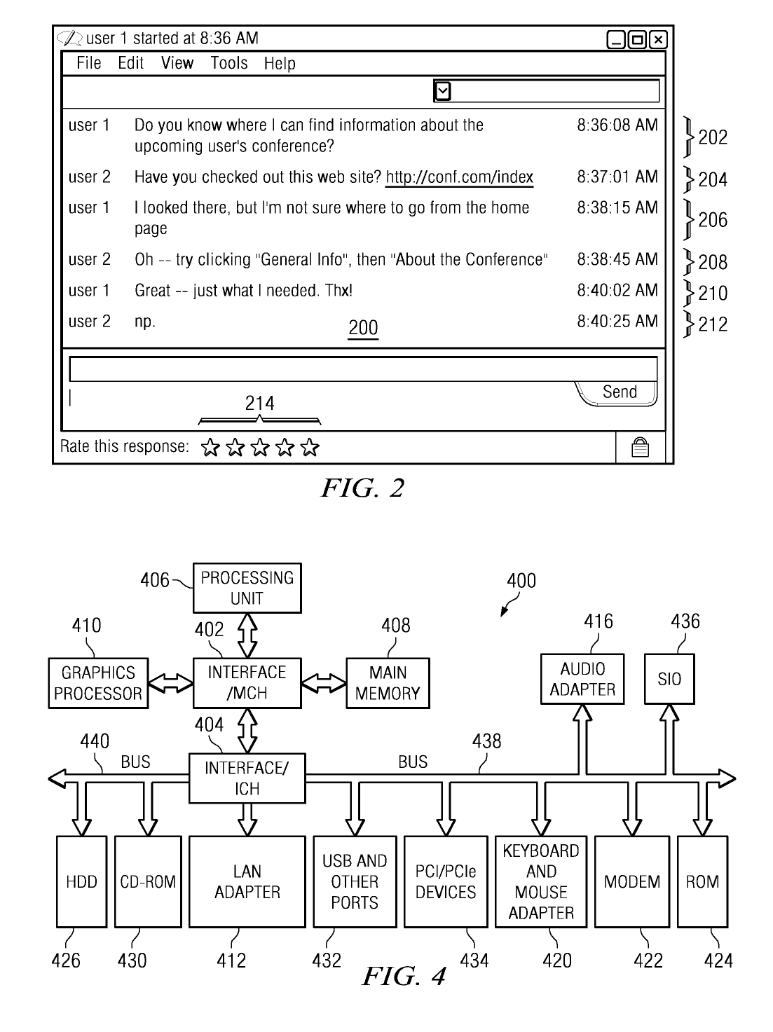

The purpose and operation of collaboration tool set 102 can be further appreciated by referring to FIG. 2, which depicts the display screen 200 of a User Interface or the like. The screen 200 shows a series of messages exchanged between User 1 of work station 102 and User 2 of work station 104. As indicated by the information of row 202 of screen 200, User 1 sends a message to User 2 at 8:36 AM, requesting certain information. As shown by row 204, User 2 responds to the query by User 1 at 8:37 AM. Subsequent messages exchanged between the users, shown by information at respective rows 206, 208, 210 and 212, indicate that User 2 successfully provides the information needed by User 1 at 8:40 AM.

By automatically monitoring and recording each of a series of instant messages such as those shown in FIG. 2, together with the respective times thereof, the collaboration tools 103 acquire data that clearly indicates the exact time taken by a user to respond to another user's request for assistance. Moreover, it is readily apparent that such timing data is of an objective nature, and also provides a very pertinent measurement or metric of the responsiveness of the user to whom the request was directed. Promptness of response to a request for assistance is generally always desired. Thus, a response will tend to be viewed with increasing negativity, as delay in sending the response increases.

Collaboration tools 103 can usefully provide additional metrics that pertain to the responsiveness of a work station user, such as by keeping track of the percentage of emails that are opened by the user within a certain amount of time. The tools 103 can also determine how often and how quickly the user responds to questions asked by emails in which she/he is only copied and not a direct recipient. In order to recognize that an email directed to a user from another user asks a question, email collaboration component 110 could be configured to recognize the occurrence of a question mark symbol at the end of a textual statement. Alternatively, the sender could insert a code in the text that component 110 would recognize. The component 110 could also process the text of the received email using available techniques, in order to conclude that the text is a request for information.

The IM collaboration component 112 can similarly detect other data pertaining to responsiveness, in addition to capturing the speed of responsiveness of a user to a request for information as discussed above. For example, component 112 can also detect the quantity of typing contained in a response to a request, the number of primary words used therein, and the number of open concurrent sessions that a user has.

While the collaboration tools 103 are able to provide very objective data in regard to the timeliness of user responses, it is often necessary to also provide a metric that indicates the quality of each response, that is, how useful the response was to the recipient. Thus, after a response has been made, collaboration tools 103 send a message to the recipient to rate the response. In one useful embodiment, the recipient would be asked to indicate the number of stars she/he gives the response, up to a maximum number such as 5, as shown at 214 of FIG. 2.

After data pertaining to both the timeliness and the quality of usefulness of a response has been acquired by the set of collaboration tools 103, the data is stored in a database 114 of engine 105. The stored data for a particular user can then be used by combining it with other data pertaining to responsiveness or other collaborative activities of the particular user, as described hereinafter in further detail.

In addition to the information described above, which pertains specifically to responses made to requests, engine 105 receives information from other sources that likewise provide ratings or measurements of collaboration-related performance. One example of such an information source would be a repository that receives and stores data regarding the attendance of a person at meetings. The data could include the timeliness of the person in arriving at meetings, the overall number of meetings attended, and the level of involvement and participation of the person in respective meetings. Also, a negative rating associated with being late or not arriving to a meeting could be counteracted by a good reason, such as a need to deal with a customer critical situation.

Referring further to FIG. 1, there is shown engine 105 provided with a Responsiveness Manager 116, which has processing components 116a-c. Manager 116 is configured to process data, such as meeting attendance data, and to provide values based on such data for metrics that rate or score responsiveness and collaboration. For example, the performance component 116a and scope component 116b could be used to process data relating to the performance or contributions of a person at meetings, and to provide ratings or numerical values therefrom. The scheduling component 116c could perform a similar rating task based on data pertaining to timeliness in arriving at meetings, and the numbers of meetings attended over a specified period of time.

In evaluating data of the type described above, in order to derive values for metrics relating to responsiveness, it is necessary to consider pertinent policies of an associated organization. For example, the policy may state that attendance at some types of meetings is mandatory, whereas attendance at other types of meetings is completely at the discretion of each employee. Such policy would clearly impact on a computation or assessment of the value of meeting attendance. FIG. 1 shows engine 105 provided with a policy database 122, where organization policies may be stored for ready access.

Another metric that could be used to rate collaboration with other persons, in a common work group or the like, would be the speed with which phone calls are returned. Data for this metric could be obtained, for example, by tracking both the speed with which phone calls are returned, and the length of time before voicemails are first listened to by the recipient thereof.

Yet other metrics for measuring collaboration pertain to the level of expertise or expert knowledge that a person has in a particular domain, and the effort that such person makes to share her/his knowledge with others. Data for metrics of this type could be acquired by monitoring the number of tags or bookmarks attributed to the person for their expert knowledge in a domain, or by monitoring her/his involvement in updating team rooms or wikis, i.e., updateable web pages. Further useful information could be acquired by tracking persons with whom a user has collaborated most frequently, and making such information available to subjective tools that ask people for feedback.

After data pertaining to metrics of different types has been collected for a person, wherein each metric measures an aspect of collaboration of the person with others, it would be beneficial to combine different metric values to produce a comprehensive measurement of collaboration. Engine 105 is configured to carry out this task, and is thus provided with a data correlation component 118 and a severity rating component 120. For example, engine 105 could be operated to combine or align a metric representing the responsiveness of a person to receive instant messages or emails, as described above, with a metric or measurement value that pertains to the meeting attendance of the person. In a simplified approach, values for each of these metrics or measurements, respectively computed from acquired data, are selectively weighted. The weighted results are then added together, to provide the comprehensive measurement of collaboration.

Usefully, policies of the associated organization can be used in determining the weighting factor that is applied to each responsiveness or other collaboration metric. As an example, severity rating component 120 can indicate, based on organization policy, whether the data on which the particular metric relies is critical to the business of the organization, or is only of an informational nature.

Other currently available techniques for weighting and combining different metrics, in order to provide a comprehensive measurement of collaboration, may alternatively be used. Further examples of organization policy that could be used in computing collaboration metrics, or to combine them together, include identifying the target of monitoring, whether acquired results pertain to a new person in the organization, and when and how often pertinent data is to be acquired. Other policies could pertain to elements of responsiveness to a request, such as the time of first reply and the number of requests that remain unanswered.

FIG. 1 further shows the comprehensive measurement of collaboration and other information being exchanged between engine 105 and entities 124-130, through a filter 107 for data reporting and transmission. Entity 124, comprising human relations (HR) activities of an associated business organization, can use the comprehensive measurement for a person in periodic evaluations of the person. At entity 126, the comprehensive measurement can be used by the person for self help and self evaluation, and at entity 128 the measurement can be used for social networking. This could include, for example, facebooks or other websites. Policy related information could be sent to engine 105 from component 130, which pertains to a service level agreement. The comprehensive collaboration measurement could also be sent to component 130 from engine 105, for use in evaluating compliance with the agreement.

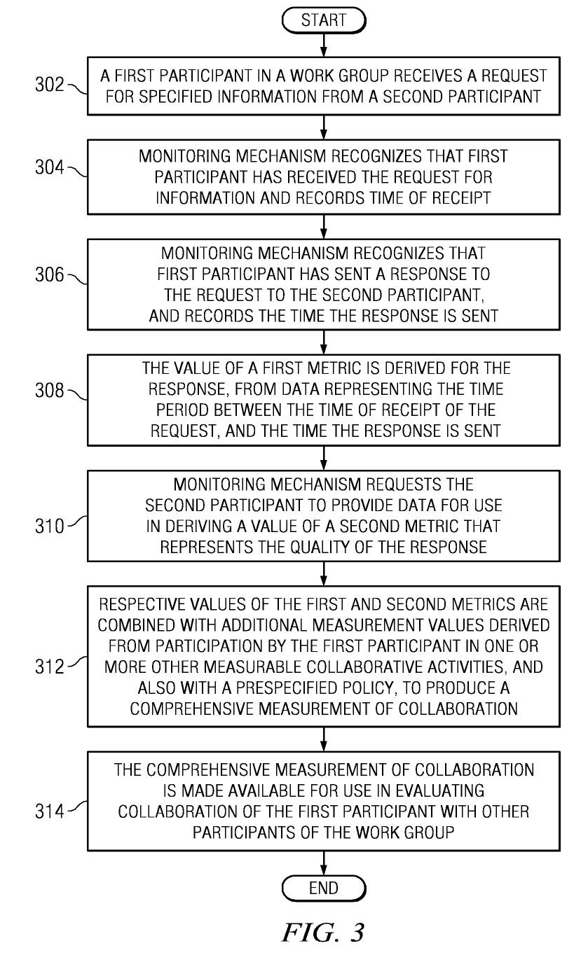

Referring to FIG. 3, there is shown a flowchart depicting selected steps for a method comprising an embodiment of the invention. At step 302 a first participant in a work group receives a request for specified information from a second participant in the group, which is sent for example as an email or instant message. It is to be emphasized that embodiments of the invention could apply to many types of organizations and associations, wherein a multiplicity of persons must collaborate or interact with one another in order to achieve common goals. At step 304, a monitoring mechanism, such as collaboration tools 103 recognizes that the first participant has received a request for information, and duly records the time of receipt.

In one embodiment, the sender of the request could insert a simple code into the text of the request message, wherein the code would be readily detected and interpreted by the monitoring mechanism. The code would clearly indicate to the monitoring mechanism that the message to the first participant was in fact a request for information. At step 306 the monitoring mechanism recognizes that the first participant has sent a response to the request, and records the time of this event. In like manner with the request, the text of the response could include a code detectable by the monitoring mechanism, which would positively indicate that the text was a response to the request from the second participant.

Referring further to FIG. 3, step 308 shows that a value for a first metric is derived for the response, based on the time period between the time of receipt of the request and the time that the response is sent. At step 310, the monitoring mechanism sends a message to the second participant, requesting data for use in deriving a value of a second metric that represents the quality of the response. This may be, for example, a request to rate response quality by indicating a number of stars, as described above. The values of the first and second metrics are then combined at step 312, together with additional measurement values, and also with policies of the organization with which the participants are associated, in order to produce a comprehensive measurement of collaboration. As described above in connection with FIG. 1, the additional measurement values are based on or derived from participation by the first participant in one or more other measurable collaborative activities. At step 314, the comprehensive measurement of collaboration is made available for use in evaluating collaboration of the first participant with other members of the work group, as likewise described above.

With reference to FIG. 4, a block diagram of a data processing system 400 is shown in which aspects of the present invention may be implemented, such as collaboration tools 103, Responsiveness Metric Processing Engine 105, and/or filters 106. Data processing system 400 is an example of a computer in which computer usable code or instructions implementing the processes for embodiments of the present invention may be located.

In the depicted example, data processing system 400 employs a hub architecture including north bridge and memory controller hub (NB/MCH) 402 and south bridge and input/output (I/O) controller hub (SB/ICH) 404. Processing unit 406, main memory 408, and graphics processor 410 are connected to NB/MCH 402. Graphics processor 410 may be connected to NB/MCH 402 through an accelerated graphics port (AGP).

In the depicted example, local area network (LAN) adapter 412 connects to SB/ICH 404. Audio adapter 416, keyboard and mouse adapter 420, modem 422, read only memory (ROM) 424, hard disk drive (HDD) 426, CD-ROM drive 430, universal serial bus (USB) ports and other communication ports 432, and PCI/PCIe devices 434 connect to SB/ICH 404 through bus 438 and bus 440. PCI/PCIe devices may include, for example, Ethernet adapters, add-in cards, and PC cards for notebook computers. PCI uses a card bus controller, while PCIe does not. ROM 424 may be, for example, a flash binary input/output system (BIOS).

HDD 426 and CD-ROM drive 430 connect to SB/ICH 404 through bus 440. HDD 426 and CD-ROM drive 430 may use, for example, an integrated drive electronics (IDE) or serial advanced technology attachment (SATA) interface. Super I/O (SIO) device 436 may be connected to SB/ICH 404.

An operating system runs on processing unit 406 and coordinates and provides control of various components within data processing system 400 in FIG. 4. As a client, the operating system may be a commercially available operating system, such as Microsoft® Windows® XP (Microsoft and Windows are trademarks of Microsoft Corporation in the United States, other countries, or both). An object-oriented programming system, such as the Java™ programming system, may run in conjunction with the operating system and provide calls to the operating system from Java™ programs or applications executing on data processing system 400 (Java is a trademark of Sun Microsystems, Inc. in the United States, other countries, or both).

As a server, data processing system 400 may be, for example, an IBM® eServer™ System p computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 400 may be a symmetric multiprocessor (SMP) system including a plurality of processors in processing unit 406. Alternatively, a single processor system may be employed.

Instructions for the operating system, the object-oriented programming system, and applications or programs are located on storage devices, such as HDD 426, and may be loaded into main memory 408 for execution by processing unit 406. The processes for embodiments of the present invention are performed by processing unit 406 using computer usable program code, which may be located in a memory, such as, for example, main memory 408, ROM 424, or in one or more peripheral devices 426 and 430.

Those of ordinary skill in the art will appreciate that the hardware in FIG. 4 may vary depending on the implementation. Other internal hardware or peripheral devices, such as flash memory, equivalent non-volatile memory, or optical disk drives and the like, may be used in addition to or in place of the hardware depicted in FIG. 4. Also, the processes of the present invention may be applied to a multiprocessor data processing system. In some illustrative examples, data processing system 400 may be a personal digital assistant (PDA), which is configured with flash memory to provide non-volatile memory for storing operating system files and/or user-generated data.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a collaborative environment wherein persons use a specified system to communicate with one another, and a first person receives a request for information from one or more other persons, a computer implemented method for providing a comprehensive measurement of collaboration that indicates the effectiveness of said first person in collaborating with said one or more other persons in said environment, wherein said method comprises the steps of:
for each response made by said first person to one of said received requests, determining the value of at least one metric that represents the value of the response;
deriving one or more additional measurement values, wherein each additional measurement value represents the value of the participation of said first person in each of one or more additional measurable collaborative activities; and
selectively combining each of said metric values with each of said additional measurement values, and also with a prespecified policy, in order to produce said comprehensive measurement of collaboration.

2. The method of claim 1, wherein:
one of said metrics comprises the amount of time taken by said first person to respond to each of said requests for information, following the receipt thereof, and another of said metrics comprises a value indicating the quality of the response by said first person to each of said requests.

3. The method of claim 2, wherein:
said specified communication system is adapted to automatically monitor and record, for each of said requests for information, the time between receipt of the request by said first person, and the time of response to the request by said first person.

4. The method of claim 3, wherein:
said specified system includes the capability to enable persons to communicate with one another by using at least email or instant messaging, selectively.

5. The method of claim 2, wherein:
each person receiving a response from said first person to one of said requests for information is queried to provide a specific value that represents the quality of the received response.

6. The method of claim 1, wherein:
said comprehensive measurement of collaboration is used by an organization to evaluate performance of said first person.

7. The method of claim 1, wherein:
said comprehensive measurement of collaboration is made available to said first person for use as a self improvement tool.

8. The method of claim 1, wherein:
one of said additional measurement values is derived from data pertaining to the meetings attendance of said first person during a specified period.

9. The method of claim 1, wherein:
one of said additional measurement values is derived from the number of tags and bookmarks in a particular domain that are attributed to said first person.

10. The method of claim 1, wherein:
one of said additional measurement values is derived from the participation of said person in updating specified updateable web pages.

11. In a collaborative environment wherein persons use a specified system to communicate with one another, and a first person receives a request for information from one or more other persons, a computer apparatus for providing a comprehensive measurement of collaboration that indicates the effectiveness of said first person in collaborating with said one or more other persons in said environment, wherein said apparatus comprises:
a device for determining the value of at least one metric that represents the value of each response made by said first person to one of said received requests;
a device for deriving one or more additional measurement values, wherein each additional measurement value represents the value of the participation of said first person in each of one or more additional measurable collaborative activities; and
a device for selectively combining each of said metric values with each of said additional measurement values, and also with a prespecified policy, in order to produce said comprehensive measurement of collaboration.

12. The apparatus of claim 11, wherein:
one of said metrics comprises the amount of time taken by said first person to respond to each of said requests for information, following the receipt thereof, and another of said metrics comprises a value indicating the quality of the response by said first person to each of said requests.

13. The apparatus of claim 12, wherein:
said specified communication system is adapted to automatically monitor and record, for each of said requests for information, the time between receipt of the request by said first person, and the time of response to the request by said first person.

14. The apparatus of claim 13, wherein:
said specified system includes the capability to enable persons to communicate with one another by using at least email or instant messaging, selectively.

15. The apparatus of claim 12, wherein:
each person receiving a response from said first person to one of said requests for information is queried to provide a specific value that represents the quality of the received response.

16. In a collaborative environment wherein persons use a specified system to communicate with one another, and a first person receives a request for information from one or more other persons, a computer program product executable in a computer readable medium for providing a comprehensive measurement of collaboration that indicates the effectiveness of said first person in collaborating with said one or more other persons in said environment, wherein said computer program product comprises:
instructions for determining the value of at least one metric that represents the value of each response made by said first person to one of said received requests;
instructions for deriving one or more additional measurement values, wherein each additional measurement value represents the value of the participation of said first person in each of one or more additional measurable collaborative activities; and
instructions for selectively combining each of said metric values with each of said additional measurement values, and also with a prespecified policy, in order to produce said comprehensive measurement of collaboration.

17. The computer program product of claim 16, wherein:
one of said metrics comprises the amount of time taken by said first person to respond to each of said requests for information, following the receipt thereof, and another of said metrics comprises a value indicating the quality of the response by said first person to each of said requests.

18. The computer program product of claim 17, wherein:
said specified communication system is adapted to automatically monitor and record, for each of said requests for information, the time between receipt of the request by said first person, and the time of response to the request by said first person.

19. The computer program product of claim 18, wherein:
said specified system includes the capability to enable persons to communicate with one another by using at least email or instant messaging, selectively.

20. The computer program product of claim 17, wherein:
each person receiving a response from said first person to one of said requests for information is queried to provide a specific value that represents the quality of the received response.
